(19) United States
(12) Patent Application Publication
(10) Pub. No.: US 2010/0223206 A1
(43) Pub. Date: Sep. 2, 2010

(54) METHOD OF PROVIDING AND SELECTING PARTICLES TO INCREASE SIGNAL-TO-NOISE RATIO IN MAGNETIC RECORDING MEDIA

(76) Inventor: Michael P. Sharrock, Saint Paul, MN (US)

Correspondence Address: Shumaker & Sieffert. P.A., 1625 Radio Drive, Suite 300, Woodbury, MN, 55125, US

(21) Appl. No.: 12/271,637

(22) Filed: Nov. 14, 2008

(51) Int. Cl. B07B 13/04; B03C 1/30; G06Q 90/00; G11B 5/78

(52) U.S. Cl. 705/500; 209/659; 209/39; 428/846

(57) ABSTRACT

A method of providing particles configured for use in magnetic recording media includes providing a set of particles having a size distribution, and removing a fraction of the set of particles from the size distribution. The fraction is less than approximately 50% by volume and includes the most massive particles in the size distribution.

### THE FIELD

Embodiments relate to magnetic recording media, and more particularly, to a method of providing and selecting particles configured for use in a magnetic recording layer in which the size distribution of the particles is selectively narrowed by removing the largest particles from size distribution to increase signal-to-noise ratio (SNR) for the magnetic recording media.

### BACKGROUND

Magnetic recoding media continue to be a popular format for storing data. Magnetic recording media generally include a substrate having one or both major surfaces coated with a magnetic recording layer. The magnetic recording layer includes magnetic particles that are coated (for example, from a dispersion) and dried on the substrate to provide a uniform magnetic layer.

The magnetic recording layer is evaluated for its ability to store and retrieve data with a minimum of undesirable noise interference. One useful evaluator of the performance of the magnetic recording layer is signal-to-noise ratio (SNR). Published research [e.g., J. C. Mallinson, IEEE Trans. Magn. vol. MAG-3, pp. 182-186 (1969); H. N. Bertram, Theory of Magnetic Recording, Cambridge University Press, 1994, pp. 261-290] teaches that the power SNR is proportional to 1/V where V is the magnetic particle volume, assumed in most studies (to simplify analysis) to be identical for all particles. Conventionally, there is a general belief that the desired approach to increased SNR in particulate recording materials is to reduce the average volume V of the particles. Vendors of metal particles for recording and manufacturers of magnetic recording media strive to minimize the average volume V in order to increase SNR (i.e., decrease the noise power relative to that of the signal).

FIG. 1 is a schematic graph of two exemplary particle size distributions A and B. Particle size distribution A provides a generally bell-shaped curve of particles distributed around an average particle volume V_{avgA}, and includes a tail of small particles and a tail of large particles on either side of the average particle volume

The conventional approach for vendors and manufacturers of magnetic recording media is to reduce the volume of all particles in distribution A, as represented by distribution B, which results in a distribution of particles ranging from small particles to large particles having a generally smaller average volume V_{avgB}. Consequently, magnetic recording media fabricated from particles of distribution B would be expected to provide an increase in signal-to-noise ratio as compared to magnetic recording media fabricated from particles of distribution A. The smallest volumes in distribution B will, however, be smaller than those in distribution A, and therefore more susceptible to thermal instability [D. J. Sleiter and M. P Sharrrock, IEEE Trans. Magn., vol. 40, pp. 2413-2415 (2004)].

We have discovered that the figure of merit previously employed by vendors of metal particles and manufacturers of magnetic recording media based on the average size of the metal particle does not truly and accurately reflect the noise performance of the particles when fabricated into magnetic recording media. For this reason, there is a need for the present invention.

### SUMMARY

One aspect provides a method of providing particles, for example via a vendor, that are configured for use in magnetic recording media. The method includes providing a set of particles having a size distribution, and removing a fraction of the set of particles from the size distribution. The fraction is less than approximately 50% by volume of the set and includes the most massive particles in the size distribution.

One aspect provides a magnetic recording media including an elongated substrate and a magnetic film coated over the elongated substrate. The magnetic film includes a first magnetic recording layer having particles with a size distribution narrowed relative to an original size distribution. The size distribution is narrowed by selectively removing up to 50% by volume of the particles, those particles having the greatest particle volume.

One aspect provides a method of selecting particles, for example by a manufacturer or via a vendor, configured to increase signal-to-noise ratio (SNR) in magnetic recording media. The method includes providing an original size distribution of particles configured for fabricating a magnetic recording layer of the magnetic recording media, and removing a portion of the particles from the size distribution to provide an effective SNR volume (V_{eSNR}) for a set of remaining particles that is substantially less than a calculated V_{eSNR} of the original size distribution of particles.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a graph of the prior conventional approach of reducing the average particle size in a particle size distribution.

FIG. 2 is a schematic cross-sectional view of a representative set of particles.

FIG. 3 is a graph of a particle size distribution for metal particles suited for fabricating magnetic recording media, the graph illustrating a set of the largest particles removed from the distribution to increase signal-to-noise ratio (SNR) in the magnetic recording media according to one embodiment.

FIG. 4 is an exemplary plot of particle width and particle length for a set of metal particles according to one embodiment.

FIG. 5 is a block diagram of another process for providing particles configured for use in magnetic recording media according to one embodiment.

FIG. 6 is a block diagram of multiple embodiments of providing particles having a narrower particle size distribution and configured for use in magnetic recording media.

FIG. 7 is a block diagram of a process for selecting particles configured to increase signal-to-noise ratio (SNR) in magnetic recording media according to one embodiment.

FIG. 8 is a schematic cross-sectional view of a magnetic recording tape according to one embodiment.

FIG. 9 is a schematic cross-sectional view of a magnetic recording tape according to another embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

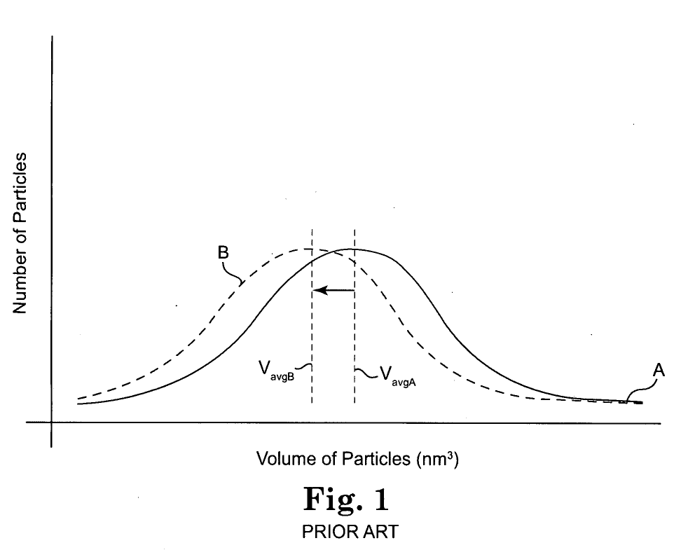

Embodiments provide methods and processes for selectively removing the largest particles from a size distribution of metal particles, which results in a narrower size distribution of the metal particles, a more accurate and useful reflection of the noise propensities of magnetic recording media fabricated from the narrower size distribution of the metal particles, and increased signal-to-noise ratio (SNR) in magnetic recording media fabricated with the narrower size distribution of the metal particles. Metal particle vendors conventionally have difficulty in providing small particles that are uniform; their subsequent attempts at providing smaller particles invariably has resulted in the average particle size being smaller (as illustrated by FIG. 1), but with the size distribution being no narrower than in the earlier materials and in many cases with the undesirable and unintended feature of the particles also having a broader size distribution. Embodiments provided herein enable metal particle vendors to provide a narrower size distribution of particles suited for fabricating magnetic recording media with increased SNR, without negatively affecting other aspects of how the vendors handle the particles.

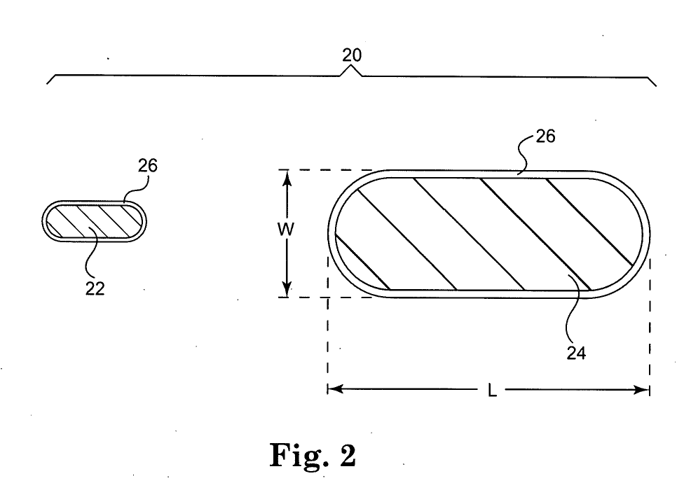

FIG. 2 is a schematic cross-sectional view of an exemplary set 20 of metallic particles 22, 24. Particles in current use are commonly acicular (elongated, approximately rod-shaped or prolate ellipsoidal) in order to provide shaped-induced magnetic anisotropy and thereby an adequate coercivity (coercive field). Particles for recording media can, however, be approximately cubical, spherical, plate-like, or otherwise shaped, with the magnetic anisotropy provided by the crystalline structure. Examples of these would be particles of iron nitride or hexagonal ferrite (e.g., barium ferrite) composition. The methods described here are equally applicable to particles of any shape or composition, and are described in terms of acicular particles for convenience only. The particles 22, 24 provide a generalized rod-shape having a length dimension L and a width dimension W (as represented by the simplified rendering of FIG. 2). The length dimension L ranges between approximately 10 and 90 nanometers (nm) in currently available materials, and the width dimension W ranges between approximately 5 and 20 nm. As illustrated, particle 22 represents a “small” particle and particle 24 represents a “large” particle.

In one embodiment, the particles each have a minor dimension and a major dimension. For acicular particles having width dimension W and length dimension L, the minor dimension is W and the major dimension is L. For circular particles, the minor dimension is the diameter.

The particles 22, 24 are suited for fabricating magnetic recording media as described in U.S. Ser. No. 10/186,126, filed on Jun. 28, 2002 and entitled “MAGNETICALLY STABLE PARTICULATE MAGNETIC RECORDING MEDIUM HAVING HIGH SIGNAL-TO-NOISE RATIO AND METHOD OF ASSESSING MAGNETIC STABILITY THEREOF,” which is incorporated herein by reference in its entirety. In one embodiment, the particles 22, 24 each have a metallic core surrounded by an oxidized shell. They are generally precipitated from a solution of iron salts, or a solution of iron and cobalt salts, with or without additional elements for the purpose of modifying shape or other properties, where the pH of the solution is adjusted to initiate precipitation of particles from the solution. The metal ions in the salt solution nucleate and precipitate as nonmagnetic (e.g., oxyhydroxide) particles. The nonmagnetic particles are dried and dehydrated to form nonmagnetic oxide particles, which are then treated in an appropriate atmosphere to reduce the metal oxides to metal, thus forming the metallic core of the particles 22, 24.

The metallic cores of the particles 22, 24 are intrinsically magnetic. It is desirable to provide the magnetic particles with a passivation layer 26. The passivation layer 26 is selectively structured on particles 22, 24 as a thin coating including oxides, hydroxides, oxyhydroxides, ferrites, or other compounds useful in preserving the underlying magnetic core of particles 22, 24.

It will be appreciated that the size distribution of the set 20 of particles 22, 24 will be strongly dependent on the size distribution of the nonmagnetic (e.g., precursor) particles precipitated from solution. If the precursor nonmagnetic particles precipitated from the solution have a broad particle size distribution, then the particle size distribution of the set 20 of magnetic particles 22, 24 will also have a broad particle size distribution.

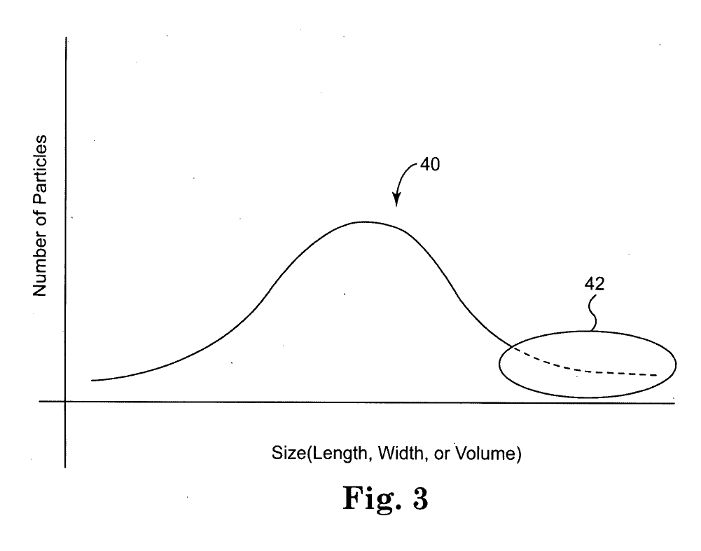

FIG. 3 is one embodiment of a graph of particle size distribution 40 for the set 20 of exemplary magnetic particles 22, 24 (FIG. 2). It will be appreciated that the number of particles in the set 20 can range from a few hundred to several thousand or more particles. The size distribution 40 will generally fall along a bell-shaped curve distributed around an average particle size. Manufacturers of magnetic particles for use in magnetic recording media strive to reduce the average particle size in the distribution of the particles, similar to the approach depicted in FIG. 1 above. The conventional approaches to improving SNR involve attempts to reduce the volume of particles in the entire distribution (or a significant fraction of the distribution), which can give rise to process limitations and/or ultimately undesirably increase the thermal magnetic instability of the particles.

It has been surprisingly discovered that the largest particles in the particle size distribution contribute disproportionately to noise. If a passivation layer is present as in the example layer 26 of example magnetic particles 22, 24 (FIG. 2), then this undesirable effect is enhanced by the passivation. It will be appreciated that the principle of this invention applies also to particles not having a passivation layer. In one embodiment, substantially only the particles 42 with the greatest mass in the particle size distribution 40 are removed and discarded prior to fabricating magnetic recording media with the remaining particles, which has been discovered to decrease noise relative to signal amplitude and thereby increase SNR in the fabricated magnetic media. In one embodiment, only the largest particles 42 (e.g., the particles with the largest dimensional size) in the particle size distribution 40 are removed and discarded prior to fabricating magnetic recording media with the remaining particles, which has been discovered to decrease noise relative to signal amplitude in the fabricated magnetic media.

Power signal-to-noise ratio (SNR) is proportional to 1/V, where V is the particle volume, if all particles are identical in shape/size.

We have found that if the particles are not identical in size and/or magnetization intensity then the above simple relationship must be modified by summing the noise contributions of particles of the various sizes present, so that SNR is expected to be proportional to

(ΣviMi)²/Σ(viMi)² Σvi,

where the summation Σ is over all the individual particle volumes vi, with each particle having its own magnetization intensity Mi, which tends to be larger for larger vi, especially in particles having a passivation layer.

The effective value of V for determining SNR (V_{eSNR}) can be calculated by setting the expression above equal to the simple form 1/V and solving for V,

$$\begin{matrix}{V}_{eSNR} = \sum {( viMi )}^{2} \sum vi / {( \sum viMi )}^{2} \\ = \sum {( viMi / Mav )}^{2} \sum vi / [ {( \sum viMi )}^{2} / {Mav}^{2} ] , \\ ( where Mav is the volume average of M ) \\ = \sum {( viMi / Mav )}^{2} \sum vi \\ = [ Average {of ( viMi / Mav )}^{2} ] / [ Average of volume vi ]\end{matrix}$$

The value of V_{eSNR} will in general be larger (typically by a factor of two) than the average value of vi, as a result of: 1) The square of vi in the average; and 2) The weighting of the magnetization intensity ratio (Mi/Mav)², which is usually larger for large particles because the passivation layer 26 accounts for only a small portion of the particle volume. The quantity (viMi/Mav) is referred to as “the magnetization-weighted particle volume.”

Consequently, the largest particles 42 contribute disproportionately to noise due to their size. The generation of noise is analogous to static on the radio, and larger particles in magnetic recording media create an effect similar to a large pulse of static.

With additional reference to FIG. 2, the small particle 22 and the large particle 24 each include a passivation layer 26. The passivation layer 26 is approximately the same thickness for the small particle 22 and the large particle 24. The core of each particle 22, 24 is metallic (and therefore magnetic). As a consequence, the passivation layer 26 on the large particle 24 accounts for a smaller fraction of the total volume of particle 24 since the remainder of the particle is the large metallic magnetic core. However, the passivation layer 26 on the small particle 22 accounts for a large percentage (and can be most of) the particle volume. Consequently, the large particle 24 contributes disproportionately to the noise, partly due to its size, but also because large particles 24 are more strongly magnetic on average because the magnetic core is large and the passivation layer 26 accounts for only a small portion of the particle volume.

The SNR is improved if the number of particles per bit is increased. In other words, it is desirable to have smaller particles. Conventionally, small particles are provided by manufacturers by reducing the size of all particles in distribution 40. It is challenging for the manufacturers to make small particles uniform. In their attempts to provide smaller particles, the manufacturers reduce the particle size of all particles in the distribution as depicted by FIG. 1, which can have the undesirable effect of actually broadening the particle size distribution.

In contrast, and as taught herein, it has been surprisingly discovered that selectively removing the largest particles 42 from the particle size distribution 40 strongly increases SNR. Eliminating a relatively small number of the particles 42 (for example only the largest 30% or fewer) from the distribution, while leaving the rest of the distribution unchanged, has been determined to have a significant effect on SNR properties.

Removal of a percentage of particles means removing a percentage of particles by count, unless specifically stated otherwise to mean removing a percentage of particles by volume.

The conventional approach for vendors and manufacturers of magnetic recording media is to reduce the volume of all particles in distribution, which alters both ends (the small and large particle ends) of the distribution. In contrast, the portion of the size distribution 40 having the small particles (e.g., the left side of the distribution 40) has not been altered, such that the susceptibility to thermal instability of media fabricated from the narrower size distribution of particles is not aggravated.

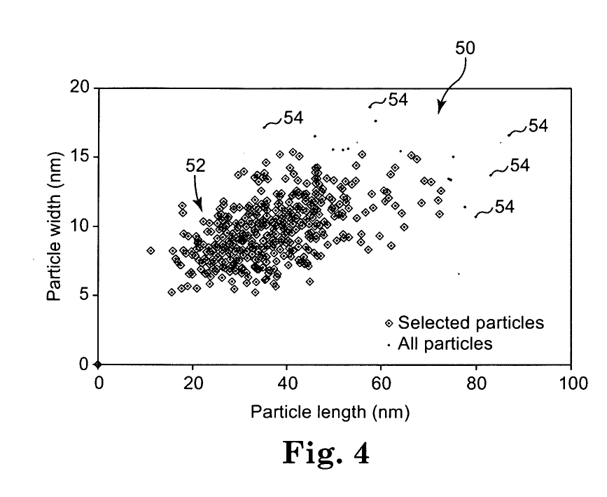

FIG. 4 is an exemplary plot of particle width and particle length for a set 50 of metal particles according to one embodiment. In one embodiment, the particles are identified and measured by transmission electron microscopy (TEM) and the set 50 is plotted according to particle width and particle length. The set 50 of particles includes a subset 52 of particles selected for fabricating a magnetic layer of a magnetic recording media, and a fraction 54 of particles selectively removed from set 50. In an exemplary embodiment, the set 50 of particles includes approximately 481 particles, and the subset 52 of particles selected for fabricating into a magnetic recording layer includes about 97% of the particles in the set 50 (or about 466 particles). The fraction 54 of the set 50 of particles that are discarded from the set 50 amounts to about 3% of the particles (about 15 out of 481), those characterized as having the greatest length and width. In one embodiment, the fraction 54 of particles discarded from the set 50 includes all particles having a length greater than approximately 74 nm and a width greater than approximately 15 nm. In one embodiment, discarding 3% of the total number of particles (those having the largest dimensions) in the set 50 significantly improves SNR.

For example, the entire set 50 of particles (having the original size distribution 40 shown in FIG. 3) was evaluated to have an average particle volume of 3265 nm³ and a calculated effective value of V for SNR V_{eSNR} of 7957 nm³. The sample remaining after eliminating the fraction 54 of largest particles had an average particle volume 3006 nm³ and an effective value of V for SNR V_{eSNR} of 6175 nm³. Thus, the average particle volume was reduced by 7.7%. Under the conventional theory in which SNR is dependent only on the average volume, the calculated gain in SNR is 0.36 dB. However, by discarding the fraction 54 of particles from set 50, the calculated noise volume V_{eSNR} is in fact reduced by 22.4% for a predicted gain in SNR of 1.1 dB. Thus, eliminating 3% of the total number of particles produces a significant increase in SNR, while still utilizing the remaining 97% of the particles in the set 50. The total volume of the discarded particles is in this example is 11% of the total volume of the original set of particles, so that 89% of the original material can be utilized to fabricate recording media.

Embodiments provide improved magnetic media fabricated by removing a portion of the particles from the original size distribution of particles to provide an effective SNR volume (V_{eSNR}) for a set of remaining particles, where the V_{eSNR} for the set of remaining particles is substantially less than a calculated V_{eSNR} of the gathered size distribution of particles. That is to say, the final V_{eSNR} is appreciably lower than the V_{eSNR} for the original set of particles.

In one embodiment, the original size distribution 40 has an average minor dimension of Ma, and the size distribution is narrowed by selectively removing particles 54 whose minor dimension exceeds Ma by approximately 30%.

In one embodiment, the size distribution is narrowed by selectively removing particles 54 whose minor dimension exceeds Ma by approximately 50%.

In one embodiment, the size distribution is narrowed by selectively removing approximately 20% of the particles 50, those having the greatest particle volume.

In one embodiment, the particles are acicular with the minor dimension being particle width W, and the size distribution is narrowed by selectively removing approximately 20% of the particles 50, those having the greatest particle width.

In one embodiment, the size distribution is narrowed by selectively removing approximately 20% of the particles 50, those having the greatest length.

In one embodiment, all particles having a volume greater than the average particle volume of the original distribution, as calculated from the length and width of cylindrical shapes, by a factor of 1.5 are discarded.

In one embodiment, all particles with a volume greater than 9000 nm³, as calculated from the length and width of cylindrical shapes, are discarded.

In one embodiment, the size distribution is narrowed by selectively removing approximately 40% by volume of the particles, those particles having the greatest particle volume.

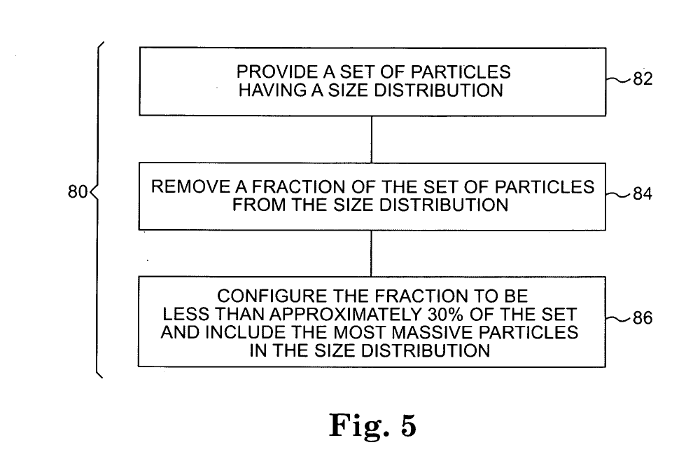

FIG. 5 is a block diagram of a process 80 for removing a fraction of particles from a particle size distribution according to one embodiment. The process 80 includes providing a set of particles with a characterized size distribution at 82. At 84, a fraction of the set of particles is removed from the size distribution. In one embodiment, the fraction of the particles that is removed is similar to the fraction 54 depicted in FIG. 4. At 86, the fraction of particles removed from the set of particles is configured to be less than approximately thirty percent of the particles, less than approximately fifty percent of the total volume of particles, and includes the most massive particles in the size distribution. In this manner, the largest particles (whether in length or in width or in volume) that disproportionately contribute to noise generation and magnetic recording media are discarded.

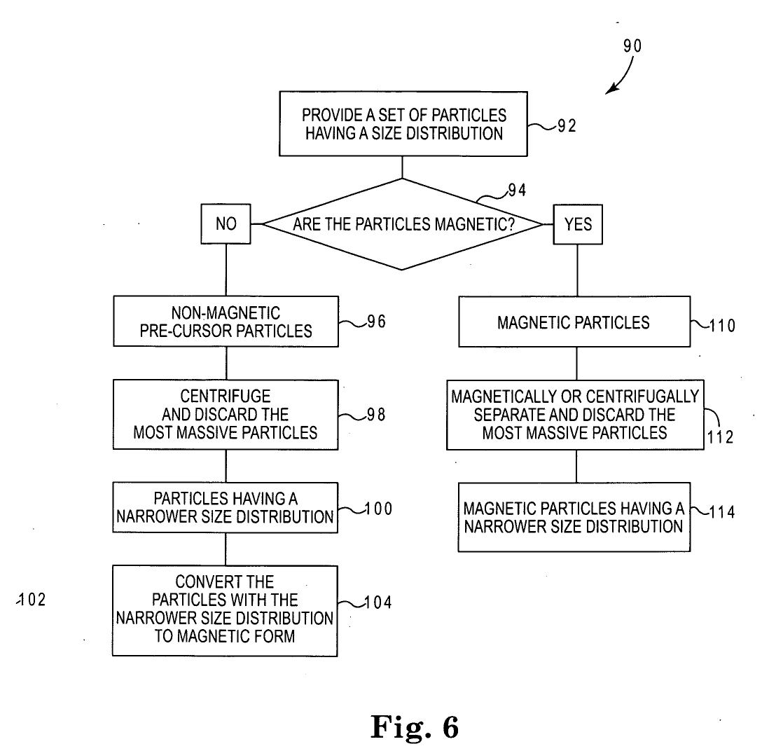

FIG. 6 is a block diagram of a process 90 providing various embodiments of removing a fraction of the largest particles from a size distribution of particles to increase SNR according to one embodiment. Process 90 includes providing a set of particles having a size distribution at 92. At 94, nonmagnetic particles are separated in a different manner than magnetic particles. For example, nonmagnetic precursor particles are provided at 96 and centrifuged to discard the most massive particles at 98. As described above, nonmagnetic precursor particles are precipitated from a solution in a manner that is suited for centrifugal separation. Suitable centrifuges include bowl centrifuges and disc centrifuges. One suitable disc centrifuge configured to separate particles in the 1-100 nm size range is available from LOT-Oriel, GmbH & Co., Darmstadt, Germany. At 100, particles having a narrower size distribution are provided as the largest particles in the distribution are discarded. In one embodiment, the particles having the narrower size distribution are a subset of the set of particles provided at step 92, where the discarded particles account for less than about fifty percent by volume of the initial distribution. In one embodiment, the particles having the narrower size-distribution are optionally dried and pelletized. At 104, the particles with the narrower size distribution are made magnetic, for example by reducing the oxides or oxyhydroxides of the precursor particles to metal.

Magnetic particles can be separated according to size by centrifugation, as in the case of nonmagnetic precursor particles, but can also be separated by magnetic means. At 110, magnetic particles are identified and separated to discard the most massive particles at 112. In one embodiment, the most massive particles are magnetically separated in a high-gradient magnetic field configured to attract and capture the largest, most massive particles. Suited magnetic separators are available from Puritan Magnetics, Inc., Oxford, Mich., or from Dexter Magnetic Technologies Inc, Elk Grove Village, Ill. In one embodiment, the fraction of the magnetically separated/discarded largest and most massive particles is similar to the fraction 54 (FIG. 4). At 114, magnetic particles having a narrower size distribution are provided.

Other methods of separating the most massive particles, or the particles of greatest dimensions, may be employed without departing from the fundamental concept of this invention.

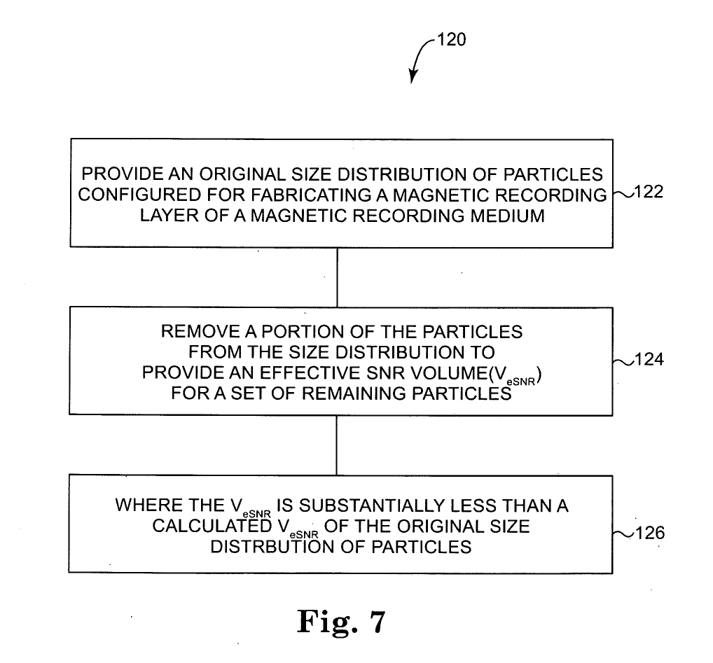

FIG. 7 is a block diagram of a process 120 of selecting particles configured to increase SNR in magnetic recording media. At 122, a size distribution of particles is gathered. V_{eSNR} is calculated as the average of the square of the magnetization-weighted particle volume (defined above) divided by the average of the particle volume for the entire original set of particles. At 124, a portion of the particles is removed from the size distribution to provide an average effective SNR volume V_{eSNR} for a set of the remaining particles that is, at 126, substantially less than a calculated V_{eSNR} of the original size distribution of particles. The new value for the remaining particles is appreciably smaller than for the original set of particles, so as to achieve a desired increase of SNR.

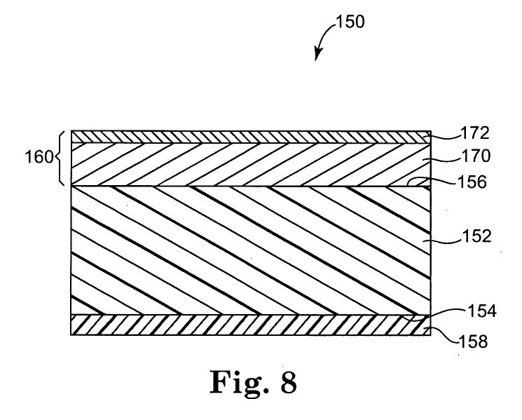

FIG. 8 is a schematic cross-sectional view of a magnetic recording tape 150 according to one embodiment. The magnetic recording tape 150 includes a substrate 152 defining a first surface 154 and a second surface 156 opposite first surface 154, a backside 158 applied to the first surface 154, and a magnetic film 160 or magnetic side 160 applied to the second surface 156. The substrate 152 provides a support or carrier for the tape 150, and the magnetic side 160 generally extends over the substrate 152 to provide a magnetically recordable medium. In one embodiment, the magnetic side 160 includes a support layer 170, a magnetic recording layer 172 disposed on the support layer 170, and particles having a narrowed size distribution described herein distributed or disposed in the magnetic recording layer 172. The support layer 170 extends over the second surface 156 of the substrate 152, and in one embodiment the support layer 170 is directly bonded to the substrate 152. In other embodiments, the support layer 170 is bonded to the substrate via an intermediate layer (not shown), such as a primer layer. The magnetic recording layer 172 extends over and is directly bonded to the support layer 170.

The magnetic recording layer 172 includes particles having a size distribution narrowed relative to an original size distribution, where the size distribution is narrowed by selectively removing a portion of the particles from the original size distribution by any of the embodiments described above, for example approximately 20% of the particles, those having the greatest particle volume.

In one embodiment, the magnetic recording tape 150 is configured for use in high density recording applications, such as for use with T10000, LTO3, LTO4, LTO5, Quantum S5, Quantum S6, 3592, or other suitably designed magnetic recording tape drives, while simultaneously providing a durable tape.

In one embodiment, the magnetic recording tape 150 is provided in a suitable LTO4 or LTO5 tape cartridge and is configured to conform to specifications of such cartridges employed in LTO4/LTO5 drives. In one embodiment, the magnetic recording tape 150 has a width or form factor of 0.5 inch, is less than 10 microns thick, and the magnetic side 160 is configured to support at least a 30 MB/in² net uncompressed density utilizing a linear density of at least 200 kbpi.

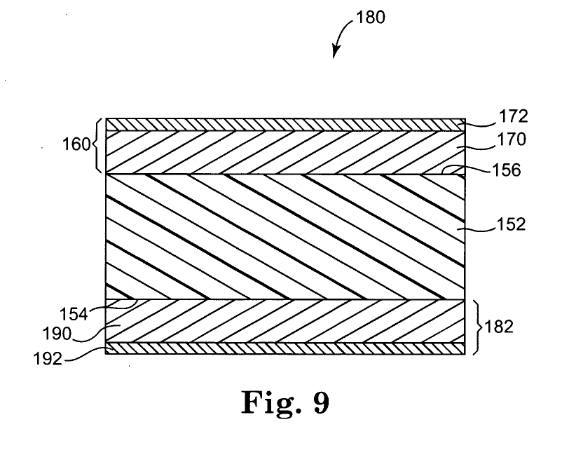

FIG. 9 is a schematic cross-sectional view of a magnetic recording tape 180 according to another embodiment in which the tape 150 describe above is modified to include a second magnetic film 182 or a second magnetic side 182. Magnetic recording tape 180, except for those differences specifically enumerated herein, is substantially similar to the magnetic recording tape 150 (FIG. 8). The second magnetic film 182 is similar to the first magnetic film 160 and in one embodiment includes a support layer 190 and a magnetic recording layer 192 with particles having a narrowed size distribution described herein distributed or disposed in the magnetic recording layer 192.

The second support layer 190, which is similar to the support layer 170 (FIG. 8), is coated over the first surface 154 of the substrate 152. The second magnetic recording layer 192 is similar to the first magnetic recording layer 172 described above and extends over the second support layer 190 opposite the first magnetic recording layer 172. As such, the second magnetic recording layer 192 defines a second exposed magnetic recording surface opposite the first exposed magnetic recording surface 172.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations to selecting/providing particles employed in the fabrication of magnetic recording media as discussed herein.

What is claimed is:

1. A method of providing particles configured for use in magnetic recording media, the method comprising:
providing a set of particles having a size distribution; and
removing a fraction of the set of particles from the size distribution, the fraction less than approximately 50% by volume of the set and comprising the most massive particles in the size distribution.

2. The method of claim 1, wherein the fraction comprises substantially only the most massive particles in the size distribution.

3. The method of claim 1, wherein the particles comprise nonmagnetic precursor particles, and removing a fraction of the set of particles from the size distribution comprises centrifuging the nonmagnetic precursor particles to discard the most massive particles from the set of particles and providing a remaining narrower size distribution of particles.

4. The method of claim 3, comprising converting the remaining narrower size distribution of particles to a magnetic form of particles.

5. The method of claim 1, wherein the particles comprise magnetic particles, and removing a fraction of the set of particles from the size distribution comprises at least one of magnetically and centrifugally separating the most massive particles from the set of particles and providing a remaining narrower size distribution of particles.

6. The method of claim 1, wherein the particles comprise rod-shaped particles having a width and a length greater than the width, and removing a fraction of the set of particles from the size distribution comprises removing up to 30% of the particles, those particles having greatest width.

7. The method of claim 1, comprising removing up to 30% of the particles, those particles having greatest volume.

8. A magnetic recording media comprising:
an elongated substrate; and
a magnetic film coated over the elongated substrate, the magnetic film comprising a first magnetic recording layer comprising particles having a size distribution narrowed relative to an original size distribution;
wherein the size distribution is narrowed by selectively removing up to 50% by volume of the particles, those particles having the greatest particle volume.

9. The magnetic recording media of claim 8, wherein the particles each have a minor dimension and a major dimension, the original size distribution comprising an average minor dimension of Ma, and the size distribution is narrowed by selectively removing particles whose minor dimension exceeds Ma by approximately 50%.

10. The magnetic recording media of claim 9, wherein the size distribution is narrowed by selectively removing particles whose minor dimension exceeds Ma by approximately 30%.

11. The magnetic recording media of claim 9, wherein the particles are acicular with the minor dimension being particle width, and the size distribution is narrowed by selectively removing up to 30% of the particles, those particles having the greatest particle width.

12. The magnetic recording media of claim 8, wherein an effective SNR volume (V_{eSNR}) for the particles having the size distribution narrowed is substantially less than a calculated V_{eSNR} of particles in the original size distribution.

13. The magnetic recording tape of claim 8, further comprising:
a second magnetic film coated over the elongated substrate opposite the first magnetic recording layer;
wherein the second magnetic film comprises a second magnetic recording layer comprising particles of the narrowed size distribution in which up to 50% by volume of the particles, those particles having the greatest particle volume have been selectively removed from the original size distribution.

14. A method of selecting particles configured to increase signal-to-noise ratio (SNR) in magnetic recording media, the method comprising:
providing an original size distribution of particles configured for fabricating a magnetic recording layer of the magnetic recording media; and
removing a portion of the particles from the size distribution to provide an effective SNR volume (V_{eSNR}) for a set of remaining particles, wherein the V_{eSNR} for the set of remaining particles is substantially less than a calculated V_{eSNR} of the original size distribution of particles.

15. The method of claim 14, wherein the V_{eSNR} is calculated as the average of the square of the magnetization-weighted particle volume divided by the average of the particle volume.

16. The method of claim 14, wherein removing a portion of the particles from the size distribution comprises removing a fraction of the particles from the size distribution, the fraction less than approximately 50% by volume and comprising only the most massive particles in the size distribution.

17. The method of claim 14, wherein providing an original size distribution of particles comprises purchasing particles with a size distribution from a vendor, the particles selectively processed to remove a fraction of only the most massive particles from the size distribution.

18. The method of claim 17, wherein the particles comprise nonmagnetic precursor particles, and removing a portion of the particles from the size distribution comprises centrifuging the nonmagnetic precursor particles to separate the most massive particles out of the size distribution before conversion of the precursor particles to magnetic form.

19. The method of claim 14, wherein the particles comprise magnetic particles, and removing a portion of the particles from the size distribution comprises one of centrifuging the most massive particles out of the size distribution and magnetically separating the most massive particles away from the size distribution.

20. The method of claim 14, wherein removing a portion of the particles from the size distribution comprises separating out substantially all particles with a volume greater than an average particle volume of the original size distribution by a factor of approximately 1.5-3.0.
